(19) United States
(12) Patent Application Publication
(10) Pub. No.: US 2005/0148388 A1
(43) Pub. Date: Jul. 7, 2005

(54) Method and system for interaction with real-time events from a remote location, through use of a computer, game console or other module

(76) Inventors: Fabricio Vayra, Alexandria, VA (US); Brad R. Newberg, Reston, VA (US)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 10/893,526

(22) Filed: Jul. 19, 2004

Related U.S. Application Data
(60) Provisional application No. 60/487,613, filed on Jul. 17, 2003.

(51) Int. Cl. A63F 13/00

(52) U.S. Cl. 463/32

(57) ABSTRACT

The invention provides a system and method that allows individuals to interact with various real-time events, including objects and occurrences in those events, replicated through a virtual reality rendering, so as to allow an individual(s) to actually compete within real-time events and with the actual event competitors from a distance. The invention captures and stores data from real-time events, allowing an individual(s) to access that data, utilizing a virtual reality interface, and accurately replicate and interact with the occurrences of a real-time event though a virtual realty rendering of the specific event from which the data was captured and stored. By capturing and storing such data on a computer server, the virtual reality recreation of the event can be accessed and rendered an unlimited number of times, thereby allowing the individual(s) to compete within the event at the time it occurs (i.e. real time) or at any time in the future.

### FIELD OF INVENTION

The present invention generally relates to a method and system providing the capability to interact with real-time events via processors and position determination features, and more particularly, to a method and system by which an individual(s) can interact with real-time events, from a distance, through a virtual reality interface via a computer, game console or other module and computer networks.

### BACKGROUND OF THE INVENTION

Currently, an individual(s) has several options by which he/she can interact with computerized virtual reality settings. One example is where an individual interacts with events and objects within a virtual reality setting that are controlled by a combination of pre-programmed events and artificial intelligence (“AI”). For example, an individual can maneuver a virtual rendering of a race car within a virtual rendering of a race track and compete against virtual renderings of competitor race cars. In this example, all objects, occurrences and actions that transpire (e.g., weather conditions, movements of and positioning of competing cars) are dictated by either predetermined and/or pre-programmed instructions (e.g., it always rains on the oval race track) or AI (e.g., a competing race car, within a range of instructions, attempts to win the race).

A sample of such conventional systems is the “NEED FOR SPEED: HIGH STAKES” (“High Stakes”) computer game distributed by Electronic Arts of Redwood City, California, when used in “single player arcade” mode. When an individual “plays” the game in “single player arcade” mode within the virtual reality of High Stakes, the individual controls only the actions of his/her virtual rendering of his/her race car. The individual interacts with the competitor cars, but all competitor cars and other event movements and parameters are dictated by either pre-programmed instructions or AI.

A second existing example occurs when an individual interacts with events and objects within a virtual reality setting, but the actions or movements of certain objects within that setting are dictated by another individual(s) input or instruction. To illustrate using the race example from above, an individual interacting within a virtual rendering of a race scenario could compete against a virtual rendering of competitor race cars, where the actions or movements of one or more of the competitor cars would be controlled by another individual(s)'s input or instruction. That/those other individual(s) would send input or instructions to control the actions or movements of his/their competitor cars through a virtual reality interface, which could be viewed from the first individual's computer at a different location on a computer network. A sample of conventional systems for this example is again High Stakes this time played in “connect players” mode through a network connection by two or more individuals.

In general, High Stakes and other current samples of virtual reality interactive games allow only very limited interaction with reality by limiting a user's “virtual reality” experience to pre-programmed or AI occurrences, or a combination of computer programmed events and input from third persons within the virtual reality. As a result, these conventional systems can become repetitive because they are limited by the finite number of preprogrammed scenarios. Over time, users of such systems become familiar with the various preprogrammed scenarios and may lose interest as the program or game becomes predictable. In addition, many users would be attracted to systems that more accurately track and allow interaction with reality (e.g., actual race results or actual game plays) as opposed to systems that are preprogrammed and repetitive in nature.

### SUMMARY OF THE INVENTION

In view of the foregoing description of conventional systems, it would be advantageous to have a system and method that allows an individual(s) to enter into a virtual reality setting, which represents and replicates real-time events so as to allow an individual to interact with such real-time events from a distance. In addition, the present invention provides an individual(s) with the ability to interact with various real-time objects and occurrences, replicated through a virtual reality rendering, so as to allow an individual(s) to actually compete within real-time events and with the actual event competitors from a distance.

In addition, the present invention captures and stores data from real-time events, allowing an individual(s) to later access that data, utilizing a virtual reality interface, and accurately replicate and interact with the occurrences of a real-time event through a virtual realty rendering of the specific event from which the data was captured and stored. By capturing and storing such data on a computer server, the virtual reality recreation of the event can be accessed and rendered an unlimited number of times, thereby allowing the individual(s) to compete within the event at the time it occurs (i.e. real time) or at any time in the future.

In other words, the present invention is designed to receive information in real time from a variety of events, including specific information about that event, such as player movements, interruptions in the event, environmental conditions, etc., and reconstruct that event in a virtual reality environment with all relevant parameters of time, place, movement and positioning of objects and persons replicated and represented to near exactness within the virtual reality environment. The present invention further allows a person outside of the event, from any distance, to enter a virtual reality setting through a computer, game console or other module, such as a telephone device or other hand-held or mobile device, and participate in an event, either in real-time, or at a later time, as if he/she were actually in the real-time event. In one embodiment, the individual(s) and the virtual reality rendering of the individual(s) would be affected by all of the parameters and actions of the real-time event (and objects located within the real-time event), although he/she would have limited or no effect on the events taking place in real-time.

The example used here is that of a race car event, such as a Formula One or NASCAR event. Through use of the system, an individual(s) would be able to interface with real-time events whereby every aspect of the actual race would be replicated in real-time, so that the individual(s) could participate in the race, through a virtual reality interface. In addition to participating and competing within the race, the individual(s) would be able to record his/their results within each race (whether rendered in real-time or at a later time) thereby giving an individual(s) the ability to track performance and improvement.

For purposes of this example, if John Doe was an actual Formula One or NASCAR driver, his car (as well as all of the other cars in the race and various objects) would be equipped with position-determining technology (such as a GPS system or telemetry device), so that all of the movements of John Doe's car would be recorded and the data representing those movements would be sent to a server. This data would be translated (either instantaneously for real-time use or stored and then translated for later replications) into a virtual reality setting, which would then replicate, in real-time, the exact movements of John Doe's car on the track—including its position on the track, its speed, and its relative position to other cars on the track. If the race event had 32 competitor cars, including John Doe, the individual virtual-reality player using the present invention would be inserted into the race as a 33^{rd} car (or 33^{rd} and 34^{th} if two individuals were playing, for example). The actions of all 32 competitor cars actually in the race event would be shown within the virtual reality setting exactly as they are in the real-time event (E.g., If John Doe's car, during the actual race event, makes a sharp right turn, the present invention would capture and store the data of those actions and allow the individual virtual-reality player using the present invention to view and interact with John Doe's actions through a virtual reality rendering of John Doe's car, which would mimic the precise details of the action taken by John Doe during the actual race event). Moreover, the competitor cars would affect the individual's car as if he/she were interacting with the competitor cars on a real race track. (E.g., the game would be programmed so that the player's car would not be able to “pass through” other cars or objects as if they were not there. Instead, the player's car would be affected just as if it hit or bumped a wall or car at the same speed, angle and relative velocities as in real-life). Because the individual(s) will be interacting with a re-creation of the event from data, as opposed to participating in the actual event, the individual(s)'s action will not affect the actions of the actual participants and objects within the real-time event (E.g., If John Doe in the NASCAR or Formula One example above ultimately comes in first place in the actual NASCAR or Formula One event, an individual virtual-reality player using the present invention would be able to use his skill at driving his virtual reality car to interact with the recreation of the actual NASCAR or Formula One event and beat John Doe, thereby finishing in first place within the virtual reality re-creation of the event. The individual could not however make John Doe's car crash or change position relative to that of other actual event competitors. Therefore, if John Doe finished in first place and Jane Doe finished in second place within the actual NASCAR or Formula One event, the individual virtual-reality player interacting with the recreation of the actual event within a virtual reality setting would see himself/herself as finishing in first, second or third place, etc., but would never affect John Doe's position relative to Jane Doe's position—John Doe would always finish ahead of Jane Doe, and both John Doe and Jane Doe would complete the NASCAR or Formula One race in the same “time” and position relative to each other as they did in the actual event. The programming within the virtual reality, however, can be altered so that the appearance of an individual(s)'s ability to affect the competitor cars may range from complete deference to the competitor cars (e.g., an individual(s) attempting to “bump” a real-life competitor car will find that the competitor car is not affected at all, but instead, the individual(s)'s car is, in essence, bumped back; or, if an individual(s)'s car is to the right of a real-life competitor car, for example, and that car shifts right in real-time, the individual(s)'s car will be bumped or squeezed right or back to make room for the real-life competitor car) to an appearance that the competitor car is slightly or moderately affected (e.g., the real-life competitor car appears to move as if it was bumped by the competitor, but immediately moves back to its real-life position in the real race). The virtual reality recreation could also be equipped with different options to make the virtual reality recreation of the event more enjoyable to the individual virtual reality player. For just two examples of many, the player could be allowed to choose different cars with different top speeds, and accelerating and maneuvering abilities, or the player could choose different levels of difficulty making it easier or harder to beat the actual race competitors within the virtual reality recreation.

To achieve the stated and other aspects of the present invention, as embodied and described below, the invention includes a method by which the movements of all objects (e.g., race cars on a race track) are accurately tracked and such data stored. The present invention further includes a method by which data recorded and stored from a real-time event can be used to dictate the movements of objects within a virtual reality setting. The virtual reality setting would then be entered by an individual(s) over a computer network, so that the individual(s) may interact with the actual event people, competitors, and objects and compete as if he/she was actually within the real-time event.

The invention also contemplates other sporting events whereby data about the event can be collected and processed in real time and a user can compete in a virtual reality setting. This would include horse racing or any other racing event, as well as team sports, such as baseball, football, basketball and hockey. In the case of team sports, the systems and methods according to the invention allow the user to compete against an actual team and may also act as a training system so that, for example, a user can run defensive plays against an actual team's offense or run offensive plays against and actual team's defense.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

The accompanying drawings, which are included to provide a further understanding of the invention, and are incorporated in and constitute a part of this specification, illustrate embodiments of the invention. Together, with the written description, these drawings serve to explain the principles of the invention. In the drawings:

FIG. 1 is a flow diagram of a process for replicating real time events in accordance with an embodiment of the present invention; and

FIG. 2 is a block diagram of an exemplary system for replicating real time events in accordance with an embodiment of the present invention.

### DETAILED DESCRIPTION OF THE PREFERRED EMBODIMENTS

The accompanying figures show, step-by-step how real-time occurrences are translated into data representing all aspects of the real-time event and replicated in a virtual reality, whereby an individual(s) can interact within that event, from a distance.

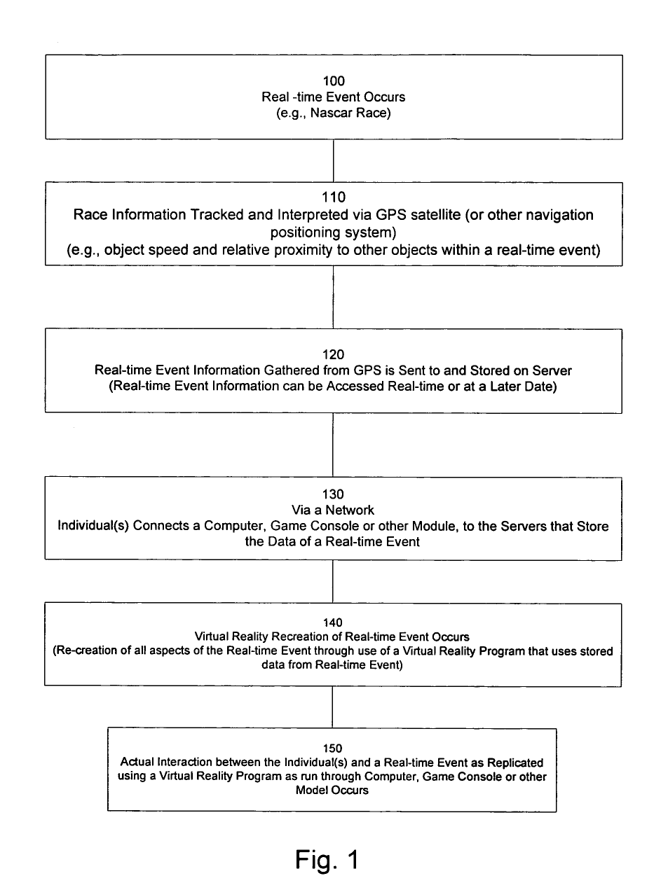

FIG. 1 illustrates a process for replicating a real time event in virtual reality. The representative example used is that of a race car event, such as a Formula One or NASCAR race. As such, using a navigation/positioning device such as GPS technology, telemetry device or similar devices, the speed, location and relative proximity of each car is recorded as data and sent, for example, to a central server or other processor and/or data repository, and existing computer technology (e.g., Java) is used to read, translate and transmit the data to recreate a virtual reality, including many various aspects of the real-time event.

The real-time event is then replicated by a virtual reality program whereby an individual(s), through use of a computer, game console or other module, such as a hand-held device, combined with a virtual reality program, accesses a simulated recreation of the information from the real-time event. The player is allowed to operate his own virtual reality car and actually interact and compete with the cars from the real-time event. This can be done, for example, simultaneously while the event is occurring in real-time, or the data representing the event can be stored, so that the player can enter the virtual-reality representation of the race with the same data and interact with it at a later time.

As shown in FIG. 1, the process begins at step 100, where a real time event, such as an actual race event (the race event is used as an example, but the present invention has applications for any other properly configured real-time event) occurs. One or more of the main objects or participants within an event (e.g., a race car), as well as any other objects within the event (e.g., people and other moving objects or potentially moving objects), as selected, are equipped with a global positioning device or other system (e.g. telemetry system) device, enabling a satellite (or other navigation positioning/tracking device, such as a helicopter equipped with proper equipment or fixed receivers) to track the exact position and movement of each object within the event (e.g., object speed and relative proximity to other objects within the event). As those skilled in the art will recognize, various other technologies besides GPS may readily be used to perform such tracking. For example, existing technologies are known in the art that utilize cellular signal strength information to determine the direction of signal. Such systems may be used in accordance with the present invention to make similar triangulations as an alternative to those methods used in the exemplary embodiment relating to GPS-like triangulation. As described earlier, the invention contemplates other real time events, such as football, basketball, hockey and baseball, where by various player positions and movements can also be tracked using the tracking devices discussed above, as well as training exercises (e.g., police and firemen training).

The process then moves to step 110 where the system then receives the data being tracked from the real time event. This information is tracked and interpreted via GPS satellite (or other navigation positioning/tracking device), and other features and devices, such as processors, interpret, track and/or gather relevant event information retrieved from properly equipped objects within the event (e.g. object speed and relative proximity to other objects within an event). For example, a satellite receives the position of each race car during a real-time race event, so that at any point in time, information received by the satellite may be used to determine the exact position of each car within said race event as well as the speed of each car and its relative proximity to other cars and objects. Another example that would allow the gathering of information involves pressure/proximity sensors on objects within the event that send data by transmitter to a properly equipped helicopter or fixed receiver/transmitter for retransmission. A combination of these two examples could also be used. When using the system for other events, the system receives various types of information pertinent to such events, such as player positions and player movements. In step 110, other types of information may also be collected, for all events such as the weather and other environmental factors, spectator information, playing field conditions or any number of other factors that may impact an event that is being tracked in real time.

The process then moves to step 120 where the collected real time data is sent to a central server or other processor and/or data collection point for tracking, gathering, interpreting, and storage. For example, in the exemplary embodiment, the server collects information in real-time and stores the information so that it can be used as input instruction, in real-time or at a later date, to dictate the movement of objects within a virtual reality setting, thereby replicating the real-time event from which the data was interpreted and stored. In this example, the time that the virtual reality replication of the event is initiated is not important, as the server accurately relays and releases all relevant data to a virtual reality program in accordance to the actual time continuum of the real-time event.

The process then moves to step 130 where a computer network, such as the Internet, is used with the server to connect each individual's computer, game console, hand held device, telephone device, or other module. In one exemplary embodiment, the data in the servers is then transmitted using Java technology, or other similar technology, to the individual's computer, game console or other module via the network.

The process then moves to step 140 where various aspects of the real-time event are recreated, such as through use of a virtual reality program. For example, events are replicated when the individual(s) enters the game using a computer, game console or other module, and a virtual reality program. The program can reside on the individual's module or on servers accessed through the network, for example. In one embodiment, the program uses the collected data to recreate the real-time event. Additional data can be pre-programmed and contained within the program, or, for example, in a data repository, to create as realistic a re-creation as possible. Examples of data that can be pre-programmed or programmed in real time include non-moving physical objects, such as the dimensions of the track itself, the stands, the fans, and advertisements, as well as the look of the participants in the actual real-time event and the look, feel, and dimensions of each driver's specific car. Other preprogrammed settings, such as weather, can be triggered to reflect the actual conditions of the real-time event being replicated. Such conditions can be programmed to affect the car of the virtual reality player in the same ways that cars in the actual event would be affected.

The process then moves to step 150 where the individual(s) then interacts with the real-time event as replicated in virtual reality. The virtual reality program thus accurately replicates the real-time event by using the data collected from the real-time event to replicate the movements and occurrences that took place during the real-time event from which the data was recorded. When the individual(s) enters the game using a computer, game console or other module and a virtual reality program, the individual(s) is thereby placed within a virtual reality re-creation of the real-time event and can interact with the objects and participants of the real-time event which are being replicated on his/her computer, game console or module. The individual(s) can therefore compete against the actual real-time competitors within a real-time event from a remote location through a virtual reality recreation of that real-time event, either simultaneously with the real-time event, or at a later time. The program may include programming that allows the individual(s) to be affected by all of the parameters and actions of the real-time event (e.g., the speed and movement of the replicated cars from the real-time event as replicated in the virtual reality setting will affect where the individual's virtual-reality car can go and whether the individual's actions would cause a crash of his/her own virtual-reality car). The program may also include programming that assigns different levels of difficulty to the individual(s)'s operation within the real-time event, providing, for example, the individual(s) with the ability to recreate as real an experience as possible (e.g., the individual(s)'s virtual-reality car may be more or less likely to lose control around corners at certain speeds, depending on the level of difficulty. In addition, the system contemplates a range of levels whereby the individual(s) could choose how rigidly the data from the actual event gets translated into the virtual reality recreation: for example, a lower “arcade” style level might rely less on the data stored from the actual event and more on pre-programmed traditional “game code,” using the data stored from the real-time event as a mere base-line from which the individual could interact with the virtual setting in more of an “arcade” manner and less as an accurate recreation of an actual event).

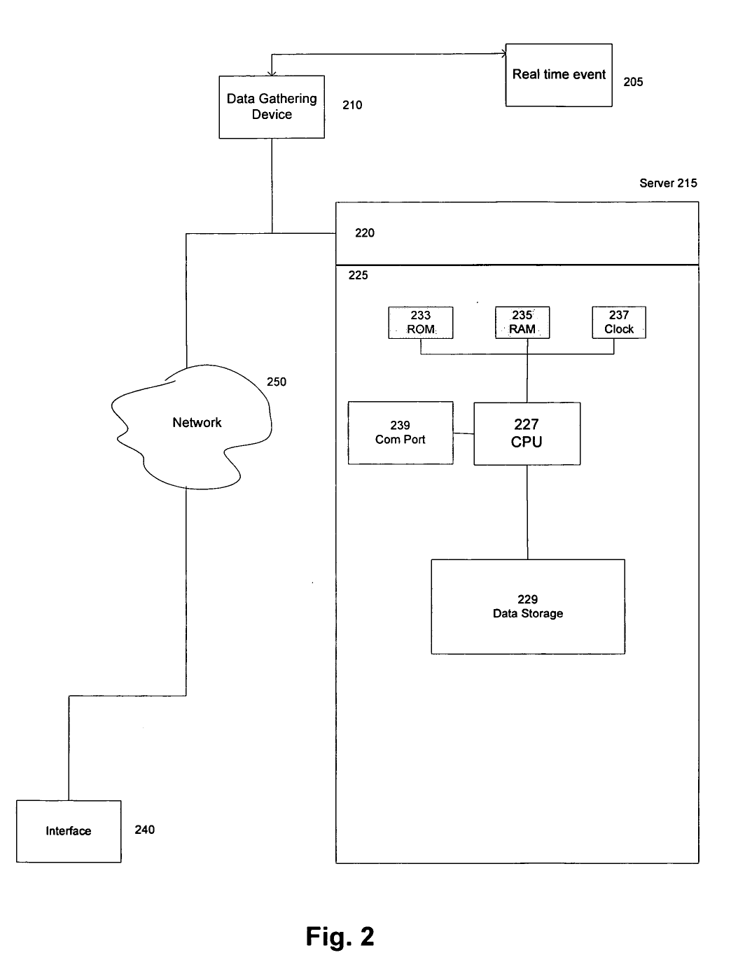

FIG. 2 shows a block diagram of the system for replicating virtual reality in accordance with embodiments of the invention. FIG. 2 shows a real time event 205. The real time event is the actual event that is occurring, such as an auto race or a football game. The competitors in the real time event 205 may be equipped with a navigation/positioning device, such as GPS technology or a telemetry device. The navigation/positioning device located at the real time event 205 is in communication with a data gathering device 210. The data gathering device 210 receives the data being collected at the real time event 205, which may include player positions and player movement and interactions, as well as information about the playing field conditions and the weather.

The data gathering device is communicatively coupled to a network server 215. The network server may include a front end application 220 and a processing application 225. The front end application 220 accesses data from the processing application 225 and presents the data to a user. The processing application may include standard hardware components, such as a central processing unit (CPU) 227, a data storage device 229, a read only memory (ROM) 233, a random access memory (RAM) 235, a clock 237, and a communications port 239. The CPU 227 is preferably linked to each of the other listed elements, either by means of a shared data bus, or dedicated connections.

The CPU 227 may be embodied as a single processor, or a number of processors operating in parallel. The data storage device 229 and/or ROM 233 are operable to store one or more instructions which the CPU 227 is operable to retrieve, interpret and execute. The CPU 227 preferably includes a control unit, an arithmetic logic unit (ALU), and a CPU local memory storage device, such as, for example, a stackable cache or a plurality of registers, in a known manner. The control unit is operable to retrieve instructions from the data storage device 229 or ROM 233. The ALU is operable to perform a plurality of operations needed to carry out instructions. The CPU local memory storage device is operable to provide high speed storage used for storing temporary results and control information.

The data storage device 229 may include databases that store information received about the real time event 205 from the data gathering device 210, as well as general information about the real time event, such as the dimensions of the track or playing field and other standard information that may be pre-programmed.

The network server 215 is also in communication with a virtual reality interface 240 via a communications network 250, such as the Internet. The network may use Java-type or related technology to transmit data between servers and computers through the network. The virtual reality interface 240 is accessible via devices such as a computer console, game console or any other device capable of receiving and displaying the virtual reality program.

Thus, referring to FIG. 2, in operation, positioning data is obtained from various objects involved in the real time event 205, such as an actual race event. Using a race car event example, the position, motion and interaction(s) of each race car within the actual race event (“Positioning Data”) would be captured for recording as data so that the Positioning Data of each car within the actual event relative to other objects and competitors within the actual event could then be entered into a virtual reality setting thereby accurately re-creating the occurrences of the actual event from which the data was captured.

The Positioning Data is then received by the data gathering device 210, such as a GPS satellite (or other navigation positioning/tracking device) that allows interpretation, gathering/tracking, and storage of relevant event information retrieved from properly-equipped objects within the event 205. For example, a satellite receiver receives the position of each race car and all other properly-equipped objects during a real-time race event, so that at any point in time, the exact position of each car and object within said race event can be determined.

The event information is then transmitted to the network server 215, where it is tracked, gathered, interpreted, and stored by the processing application 225. The processing application 225 collects and interprets the information in real-time and stores it so that it can be used as input instruction, in real-time or at a later date, to dictate the movement of objects within a virtual reality setting, thereby allowing replication of the real-time event 205 from which the data was interpreted and stored. The processing application 225 thus stores and processes the data from the real-time event 205 used to recreate the event for a user and allows the user to be included in the event and compete against the other competitors in the real time event. This may include creating a graphical environment that replicates the real time event, including representations of the competitors, the track or playing field and the weather and other environmental factors. The competitors behave in the precise manner as in the real time event based upon the event data gathered by the data gathering device 210.

The invention also provides an interface that allows the user to view the virtual reality environment that is being replicated. For example, the network 250, such as the Internet, may be used to couple a computer, game console or other module 240, such as a hand-held device or telephone device, to the server or other device or devices 215 that store and/or process the data for a real-time event 205. The data in the server 215, for example, may be transmitted using Java technology, or other similar technology, to the individual's computer, game console or other module 240 via the network 250. Alternatively, the data in the server 215, could be downloaded to or stored on a portable storage device (E.g., CD-ROM) and transferred to an individual(s) via uploading the data on the portable storage device to a virtual reality setting using a computer, game console, or other module 240. In such a case the data would still be interpreted and transmitted using Java technology, or other similar technology to re-create a real-time event and allow individuals to interact with the real-time event as captured through data in a virtual reality setting.

At the computer, game console, or other module 240, a virtual reality program (E.g., a NASCAR or Formula One video game that has pre-programmed accurate representations/replications/renderings of NASCAR/Formula One race courses and all objects and beings of a NASCAR/Formula One race), in conjunction with data from the server or other device or devices 215, replicates the occurrences of a real-time event 205 when the individual(s), for example, enters/utilizes the virtual reality program and utilizes/uploads the data captured from the real-time event 205. The data captured and stored from the real-time event 205 is then used as instructional input for various pre-programmed objects and beings within a virtual-reality program to accurately recreate all aspects of the real-time event 205, through the computer, game console, or other module 240 using a virtual reality program (E.g., NASACAR/Formula One game). The present invention would then be used to allow individual(s) to interact with and compete against the actual participants in the real-time event 205 either in real-time or at a later time (by allowing multiple individuals to access the same program through a computer network 250 or the same or multiple computer(s), game console(s), or other module(s) 240, individuals would be able to compete against other individuals in addition to the actual participants of the real-time event). The present invention also contemplates allowing an individual(s) to record and post/publish (for example, via a computer network 250) the results of their specific interaction with the virtual reality recreation of the real-time event 205 so as to compete with and/or compare to the results of other individuals who have also interacted with the virtual reality recreation of the same real-time event 205.

Example embodiments of the present invention have now been described in accordance with the above advantages. It will be appreciated that these examples are merely illustrative of the invention. Many variations and modifications will be apparent to those skilled in the art.

1. A method for rendering an interactive virtual reality environment, comprising the steps of:
collecting data relating to a real time event;
rendering a virtual reality environment based upon the collected data; and
presenting an interface to a user that allows the user to participate in the virtual reality environment.

2. The method according to claim 1, further comprising the step of modifying the rendered virtual reality environment based upon input from a user.

3. The method according to claim 1, wherein the step of collecting data includes recording data from at least one participant in the real time event.

4. The method according to claim 1, wherein the data is collected via a navigation/positioning device.

5. The method according to claim 1, wherein collected data is received from a data collection device mounted to at least one participant in an event.

6. The method according to claim 1, wherein the step of collecting data includes receiving preprogrammed settings relating to the virtual reality environment.

7. The method according to claim 1, wherein the rendered virtual reality environment is a graphical representation that is similar to or identical to the real time event.

8. The method of claim 1, wherein the real time event is one of a racing event; an individual sport and a team sport.

9. The method according to claim 1, wherein the virtual reality environment may be rendered during the real time event or at a later time.

10. The method according to claim 1, wherein the interface is presented on one of a computer, a game console and a display device.

11. The method according to claim 1, wherein a plurality of users may participate in the virtual reality environment and compete against each other.

12. An apparatus for rendering an interactive virtual environment, comprising:
a processor;
a storage device coupled to the processor and storing instructions adapted to be executed by said processor to:
receive data relating to a real time event,
render a virtual reality environment based upon the received data, and
present an interface to a user that allows the user to participate in the virtual reality environment.

13. The apparatus according to claim 12, comprising a data collection device for collecting parameters related to the real time event.

14. The method according to claim 13, wherein the parameters include one of at least one participant's position, weather conditions and playing field conditions.

15. The apparatus according to claim 12, further comprising a user device for displaying the virtual reality environment.

16. The apparatus according to claim 12, wherein the data collection device is one of a GPS device, a telemetry device or other navigation/tracking device.

17. The apparatus according to claim 12,

18. The apparatus according to claim 12, wherein the real time event is one of a racing event, an individual sport or a team sport.

19. The apparatus according to claim 12, wherein the rendered virtual reality environment is a graphical representation that is similar to or identical to the real time event.

20. The apparatus according to claim 12, wherein the virtual reality environment may be rendered during the real time event or at a later time.
